(19) United States
(12) Patent Application Publication
(10) Pub. No.: US 2025/0327381 A1
(43) Pub. Date: Oct. 23, 2025

(54) THERMALLY TRIGGERED CONFORMABLE POLYMERIC SCREEN

(71) Applicant: Schlumberger Technology Corporation, Sugar Land, TX (US)

(72) Inventors: William K. Goertzen, Lawrence, KS (US); Vinay Joshi, Lawrence, KS (US); Pratheek Bagivalu Prasanna, Lawrence, KS (US); Luke Macfarlan, Lawrence, KS (US)

(21) Appl. No.: 19/186,170

(22) Filed: Apr. 22, 2025

Related U.S. Application Data
(60) Provisional application No. 63/637,217, filed on Apr. 22, 2024.

(51) Int. Cl. E21B 43/10; B01D 29/11; B01D 39/10; B01D 39/16; E21B 36/00; E21B 43/08

(52) U.S. Cl. CPC E21B 43/10; B01D 29/114; B01D 39/10; B01D 39/1661; E21B 36/00; E21B 43/08; B01D 2239/10; B01D 2239/1291

(57) ABSTRACT

A porous structural thermoset media is described herein. A method includes generating a porous structural thermoset material comprising a glass transition temperature (T_{g}) that is greater than is greater than or equal to about 100° C. and a first diameter. The method also includes compressing the porous structural thermoset material to generate a compressed porous structural thermoset material comprising a second diameter that is smaller than the first diameter.

### CROSS-REFERENCE TO RELATED APPLICATIONS

This application claims priority to U.S. Provisional Patent Application having Ser. No. 63/637,2171, which was filed on Apr. 22, 2024, which is incorporated herein by reference in its entirety.

### BACKGROUND

The present disclosure generally relates to a porous structural thermoset media.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

In many hydrocarbon wells, inflowing fluid passes through a sand screen which filters out particulates from the inflowing oil or gas. The sand screen prevents sand from entering the wellbore and reduces damage that may occur by erosion. Conventionally, sand screens are made with a metallic mesh material. Once the sand screen is placed into the wellbore, gravel packs are pumped to fill the annulus between the screen and the formation.

In other instances, some metallic sand screens are expandable and are expanded downhole after placement in the wellbore. The result is a reduction in the annulus between the screen and the formation. The expandable screens in many instances have a limited expansion ratio, and the ability of the expandable screen to conform to borehole irregularities may not be satisfactory. Further, the ability of the expandable sand screen to resist borehole collapse may be reduced. Conventional sand screens are rated to resist greater external pressure than expandable sand screens. Expandable sand screens resist less external pressure because of plastic deformation experienced by their metallic components.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a sectional view of a sand screen positioned in a wellbore, in accordance with an embodiment of the present disclosure;

FIG. 2 is a flow diagram of a method of generating the porous structural thermoset material of FIG. 1 and deploying the porous structural thermoset material in the sand screen of FIG. 1, in accordance with an embodiment of the present disclosure;

FIG. 3 is an embodiment of a method for manufacturing porous structural thermoset material in conjunction with the method of FIG. 2 and in accordance with an embodiment of the present disclosure;

FIG. 4 is a first embodiment of a method of shaping the porous structural thermoset material into a compressed form in conjunction with the method of FIG. 2 and in accordance with an embodiment of the present disclosure;

FIG. 5 is a second embodiment of a method of shaping the porous structural thermoset material into a compressed form in conjunction with the method of FIG. 2 and in accordance with an embodiment of the present disclosure; and

FIG. 6 is a graph illustrating a selected glass transition temperature (T_{g}) used in deployment of the sand screen in conjunction with the method of FIG. 2 and in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

All numerical values within the detailed description herein are modified by “about” the indicated value, and take into account experimental error and variations that would be expected by a person having ordinary skill in the art. For example, “about” or “approximately” may refer to ±0.5%, ±1%, ±2, ±5%, ±10%, or ±15%.

As used herein, the term “coupled” or “coupled to” may indicate establishing either a direct or indirect connection (e.g., where the connection may not include or include intermediate or intervening components between those coupled) and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Present embodiments described herein generally relate to making and using a porous structural thermoset material. In some embodiments, this porous structural thermoset material can be used in sand control applications, among other applications. For example, one or more embodiments of the present disclosure relate to a porous structural thermoset material able to expand once deployed downhole to conform to an irregularly shaped wellbore for sand control operations. As further described below, the porous structural thermoset material according to one or more embodiments of the present disclosure exhibits permeability, robustness, and an expansion ratio that are favorable for sand control operations by allowing for support of the formation during the production of oil.

The porous structural thermoset material utilized herein can include a network of pores inside of the structural thermoset material. Furthermore, techniques described herein allow for the generation of porous structural thermoset material, in a geometry which can be a used a sand screen, and that is compressible. The compressed porous structural thermoset material can be expanded when deployed downhole, for example, in a borehole. By compressing the geometry of the porous structural thermoset material on the surface (e.g., during manufacture of the porous structural thermoset material), greater clearance during any running in hole (RIH) operation can be achieved.

In some embodiments, the porous structural thermoset material utilized is manufactured having a selected (i.e., predetermined) glass transition temperature (T_{g}) or a selected T_{g} within a particular range of temperatures. Compression of the porous structural thermoset material can be accomplished at a temperature above the selected T_{g} during the manufacturing process to reduce the size of the porous structural thermoset material. The resulting compressed porous structural thermoset material can then be shipped and deployed, for example, as a sand screen that is able to be expanded. This expansion can be facilitated by the application of heat and/or a heated fluid to the sand screen, raising the temperature to which the sand screed is exposed to a level above the T_{g} of the porous structural thermoset material of the sand screen. This causes the sand screen to expand so that it is in contact with the formation, for example, to provide mechanical support and reduce the likelihood of formation collapse.

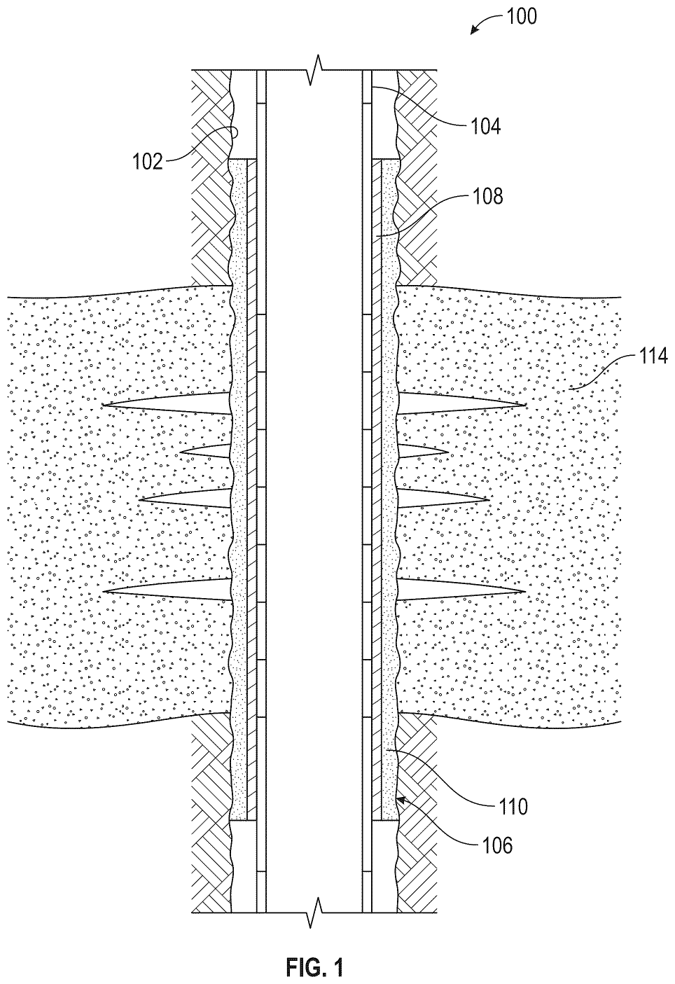

With the foregoing in mind, FIG. 1 is a sectional view of a sand screen positioned in a wellbore according to one or more embodiments of the present disclosure is shown. Specifically, the wellbore 100 includes an open bore hole 102, a production tubing string 104, which may be a base pipe according to one or more embodiments, and a sand screen 106. While wellbore 100 is illustrated as being a substantially vertical, uncased well, it should be recognized that the subject disclosure is equally applicable for use in cased wellbores as well as in horizontal and/or inclined wellbores. The sand screen 106 includes a filter member 108 and a polymeric material, such as porous structural thermoset material 110 according to one or more embodiments of the present disclosure. The sand screen 106 is shown positioned in the wellbore 100 adjacent a producing formation 114. In some embodiments, the sand screen 106 (and/or the porous structural thermoset material 110) can be, for example, an annular shaped member that can be disposed about the production tubing string 104. In addition, according to one or more embodiments of the present disclosure, the porous structural thermoset material 110 may be the only filtration agent without the use of any filter member 108. In one or more embodiments of the present disclosure, the filter member 108 can be configured for additional structural support of the porous structural thermoset material 110.

Still referring to FIG. 1, in a well completion method according to one or more embodiments of the present disclosure, at least one base pipe (e.g., production tubing string 104) may be covered with the porous structural thermoset material 110 according to one or more embodiments of the present disclosure. In some embodiments, the porous structural thermoset material 110 covering the base pipe as the production tubing string 104 may be covered with a retainer (e.g., a film) before running the base pipe as the production tubing string 104 to a location in the wellbore 100. Upon exposure to a condition in the wellbore 100, the retainer may degrade and expose the porous structural thermoset material 110 to the wellbore fluids. In one or more embodiments, various methods are employed to trigger expansion of the porous structural thermoset material 110. As the porous structural thermoset material 110 expands into and fills the annulus, the porous structural thermoset material 110 conforms to a wall of the wellbore 100. Because the porous structural thermoset material 110 is able to conform to the wellbore 100 wall in this way and has a permeability that is about equivalent to or greater than the permeability of the surrounding formation, the porous structural thermoset material 110 is able to allow formation fluids into the base pipe as the production tubing string 104 while filter debris including sand from fluids from the producing formation 114. After the downhole operation is complete, the porous structural thermoset material 110 may be detached from the base pipe as the production tubing string 104, and the base pipe as the production tubing string 104 may be lifted out of the wellbore 100.

In this manner, the porous structural thermoset material 110 can have many beneficial applications for downhole tools in the oilfield; in particular, as a conformable sand screen as sand screen 106 used in oil and/or in gas operations. The porous structural thermoset material 110 can also be applied to/relevant to downhole tools involving a porous medium, such as for filtering or sealing applications. The porous structural thermoset material 110 can be porous, allowing downhole fluids to be produced through it. Simultaneously, the pores can be small enough that erosive sand particles can be captured before they enter the completions equipment. Once in the proper location downhole (e.g., in the wellbore 100 adjacent a producing formation 114), the porous structural thermoset material 110 can expand and conform to the wellbore 100. The high strength of the porous structural thermoset material 110 can also allow it to support the wellbore 100. This support can be especially important, for example, during drawdown, as suction created by pumps drawing fluids from the producing formation 114 can destabilize the producing formation 114. The structural strength of the porous structural thermoset material 110 can allow it, for example, to inhibit collapse during drawdown, ensuring sustained production from the well.

The high mechanical strength of the porous structural thermoset material 110 is a desirable property for use in oilfield operations, allowing porous structural thermoset material to withstand large loads. In addition to the porous structural thermoset material 110 having high strength, it can also have desirable chemical compatibility. In some embodiments, the porous structural thermoset material 110, which is formed by irreversible chemical reactions to generate a crosslinked structure that does not melt (also called thermosetting polymers, thermoset resins, or thermosetting resins) can include (but are not limited to) the following chemistries and variants: polyesters, cyanate esters, epoxies, phenolics, methacrylates, melamines, vinyl esters, bismaleimides, thermoset cyclic polyolefins, polyimides, and benzoxazines. Furthermore, the compounds used in the generation of the porous structural thermoset material 110 can be thermally stable to high temperatures and can be resistant to chemical attack.

The present “structural thermoset” material can be mechanically as a rigid thermosetting polymer where the non-porous, bulk material (when cured to form a densely crosslinked network) has a modulus (compressive, flexural, tensile, or elastic) of at least, for example, approximately 0.5 GPa below the glass transition temperature (T_{g}). In other embodiments, structural thermosets typically have a T_{g} above an ambient temperature (e.g., about 25° C.). This Tg can be the temperature at which the structural thermoset material transitions from its rigid state (i.e., a hard, glassy, brittle state) to a more flexible, rubbery state. The Tg can be selectable for a given structural thermoset material, based on the materials utilized in manufacturing the structural thermoset material, so as to allow for flexibility in selecting an onset T_{g} to correspond to an environment (i.e., bottom hole temperatures) that the structural thermoset material will be exposed to when deployed.

Additionally, some embodiments, the structural thermoset can be reinforced with fillers, such as ceramic or metallic particles of various types and/or geometries, to enhance the mechanical properties of the cured porous structural thermoset material 110. This can include spherical, non-spherical, or high aspect ratio silica (both crystalline and amorphous), boron nitride, aluminosilicate, alumina, aluminum nitride, and zirconium tungstate. Metallic reinforcements can include a variety of ferrous and non-ferrous, with preference to corrosion resistant materials (i.e. nickel alloys, stainless steels, etc.). In this manner, in some embodiments, the mechanical strength, thermal stability, and thermal conductivity of the porous structural thermoset material can be modified and improved through the addition of additional materials.

The porous structural thermoset material 110 can be made to be porous. The porous structure can have a variety of purposes, including: to allow fluid to pass through the material, to filter solid particles, and/or to create an interpenetrating composite network. In some embodiments, the interpenetrating thermoset composite network can have two or more materials with vastly different thermal, viscous, mechanical, electrical, or magnetic properties. For example, in the case of the porous structural thermoset material 110 used in a sand screen 106 (or as sand screen 106) made from the porous thermoset can be designed specifically for the size distribution of sands in the formation.

The pores of the porous structural thermoset material 110 can also have a non-uniform distribution. For example, a portion of the pores in the porous structural thermoset material 110 can have relatively smaller sizes, for example, to capture sand more efficiently, while another portion of the pores in the porous structural thermoset material 110 can have larger sizes relative to the smaller sized pores. These larger sized pores would allow the porous structural thermoset material 110 to be more permeable relative to a porous structural thermoset material 110 made with only smaller sized pores.

In the case of a sand screen 106, for example, smaller sized pores could be located close to the formation 114 (e.g., along an outer portion of the porous structural thermoset material 110 that would be disposed most closely to and/or in direct contact with the formation 114) to inhibit sand ingress, while larger sized pores can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores), trimodal, or simply monomodal with a large standard deviation.

While generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

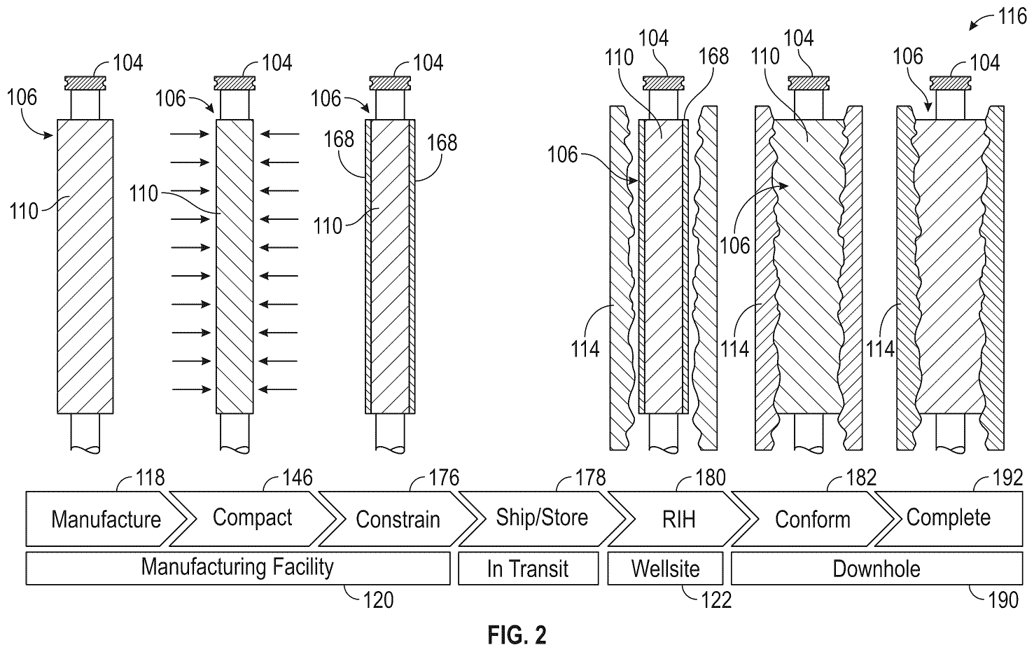

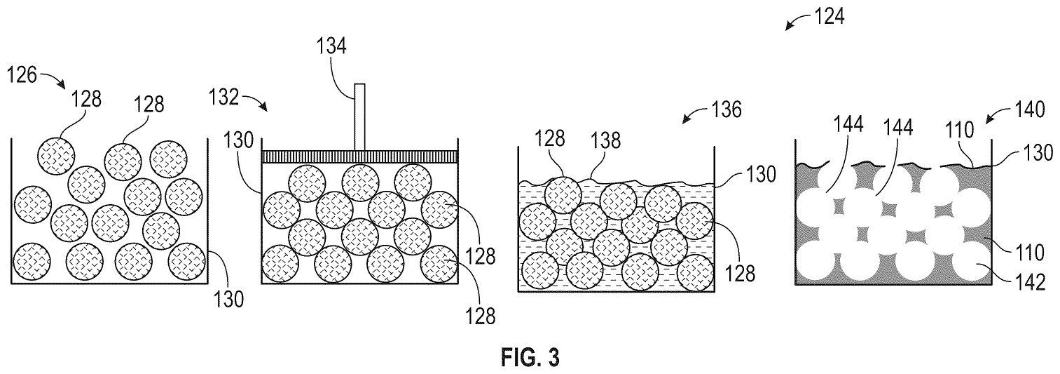

FIG. 2 illustrates flow diagram 116 of a method of generating the porous structural thermoset material 110, transporting the porous structural thermoset material 110, and deploying the porous structural thermoset material 110, for example, as the sand screen 106. In block 118, the porous structural thermoset material 110 is manufactured, for example, at a manufacturing facility 120 prior to its shipment to an operational site, for example, a wellsite 122. As illustrated in FIG. 2, the manufacturing of the structural thermoset material 110 can include disposing the porous structural thermoset material 110 (e.g., as an annular shaped member) about a production tubing string 104 as a sand screen 106. However, this portion of block 118 can be performed subsequently, for example, on site at a wellsite. One technique to manufacture the porous structural thermoset material 110 in block 118 is described below with respect to FIG. 3.

FIG. 3 illustrates a first embodiment of a method 124 of generating the porous structural thermoset material 110. As will be described in greater detail, the method 124 illustrated in FIG. 2 illustrates creation of the porous structural thermoset material 110 via encapsulating a removable material with a structural thermoset material, such as, but not limited to, a structural thermoset polymer. For example, in block 126, particles of a removable material 128 can be loaded into a mold 130. While the mold 130 is shown as an open mold, a closed mold can be used to facilitate resin injection (vs. potting in open mold). In some embodiments, mold 130 can be shaped and sized to fit within a desired sand screen 106 or the mold 130 can form a bulk porous structural thermoset material 110 shape, from which the form of the sand screen 106 is fabricated (machining, cutting, etc.). Moreover, while generation of the porous structural thermoset material 110 into a sand screen 106 is described, it should be noted that other devices and/or configurations are envisioned. For example, the porous structural thermoset material 110 can be shaped into forms for separation operations (e.g., as a separator used in separating oil and water), filtration operations (e.g., as a filter on a pump used in oil and gas operations, as an actuator or actuator device (e.g., to move to open and close a valve), or in similar operations.

The material selected as the removable material 128 can be chosen based on various properties, for example, its compressibility, the size of its particles, the manner in which it can be removed from the mold 130, and/or other characteristics. In some embodiments, the removable material 128 can be a dissolvable material. For example, salt, sugar, polyvinyl alcohol (PVA), or another liquid soluble material can be used as the removable material 128. The salt selected can include Sodium Chloride, however, additionally and/or alternatively other salts can be utilized, for example, Magnesium Chloride, Calcium Chloride, Potassium Chloride, or other suitable salts. Likewise, numerous types of sugars can be utilized as the removable material 128. The removable material 128 can be chosen to be dissolvable in the presence of water or a different liquid (e.g., a solvent). In still other embodiments, removable material 128 can be a material that melts instead of one that dissolves in the presence of a liquid. For example, removable material 128 can be, for example, paraffin wax, carnauba wax, or another material that can be removable upon exposure to heat (e.g., temperatures up to or over approximately 85° C.). In further embodiments, the removable material 128 can be a solid material that sublimes upon exposure to heat (e.g., temperatures up to or over approximately 85° C.). For example, naphthalene can be utilized as the removable material 128, since it sublimes at temperatures at or around 85° C. In some embodiments, the removable material 128 can be a mixture of two or more types of removable materials.

In conjunction with block 132, compression of the removable material 128 can be undertaken in some embodiments. This can assist in generating a desired network of removable particles, which can define a pore and pore throat network in the resulting porous structural thermoset material that is generated. In one or more embodiments, in conjunction with block 132, the removable material 128 can be compressed in the mold 130 (e.g., into a network or a layer or another structure of compressed removable material 128) prior to the porous structural thermoset material 110 being applied to the mold 130. This can be accomplished via use of a press 134 or another suitable device. This compression process can increase the loading of removable material 128 in the mold 130. The compression can also, for example, improve the porosity of the final part, as the particles of the removable material 128 are forced to have more contact with each other, ensuring that when the removable material 128 is removed, the pores generated in the porous structural thermoset material 110 from the removal of the removable material 128 are connected.

This compression process can also alter the shape of the removable material 128, which can impact the shape of the pores generated in the porous structural thermoset material 110. That is, the pore size and/or shape in the resultant porous structural thermoset material 110 can be dictated by this compression process (e.g., the amount of compression applied, by applying different compressions to different portions of the removable material 128, etc.). For example, the compression process can be applied in different directions, for example, to provide anisotropic properties. Thus, in the case of manufacturing a sand screen 106 that is annular (i.e., has an annular shape), compression could be applied axially or radially, and the direction of compression applied would affect the pore morphology.

In some embodiments, sintering (e.g., binding) of the particles of the removable material 128 can also be undertaken. Likewise, liquid (e.g., water or a liquid solvent) can be applied to the removal material 128 (or removable materials 128 if two or more materials are utilized as the removable material 128), which can be dried thereafter to form a desired network (e.g., layout of pores) in the porous structural thermoset material that is generated. The network that is created can be generated layer by layer or in bulk.

In block 136, a thermoset composition 138 (e.g., structural thermal mixture, structural thermoset formulation, structural thermoset precursor) can be added to the mold 130. The thermoset composition 138 can be added in an amount to wholly or partially cover the removable material 128. For example, the thermoset composition 138 can encapsulate and fill the interstices of the particles of the removable material 128. The thermoset composition 138 is an uncured version of the porous structural thermoset material 110. That is, in conjunction with block 136, the porous structural thermoset material 110 as a thermoset composition 138 may be in an uncured form when placed or otherwise added to the mold 130. Once added to the mold 130, the thermoset composition 138, for example, as a viscous liquid, may be cured (i.e., hardened). This curing can be accomplished by exposing the thermoset composition 138 to heat, radiation (e.g., ultraviolet light), pressure, a curing agent, and/or a catalyst. The curing of the thermoset composition 138 can result in an infusible and insoluble resultant porous elastomeric material as the porous structural thermoset material 110. In some embodiments, it may be advantageous to partially cure (e.g., as compared to fully curing) the thermoset composition 138 such that it is capable of conforming to irregularities in surfaces, shapes, and other features in a borehole.

Block 140 of FIG. 3 includes removal of the removable material 128. This removal can be performed by the application of a liquid (e.g., to dissolve the removable material 128), heat (e.g., to melt the removable material 128 or to sublime the removable material 128), and/or a catalyst to the removable material 128 and the porous structural thermoset material 110 in the mold 130. The removal process can be selected to match the material used as the removable material. In this manner, the removal process can include external stimulation that supports the removal of the particles of the removable material 128. Such external stimulation can include, for example, exposure to a solvent, a temperature change, a pressure change, agitation, and/or or ultrasonic waves. Upon removal of the removable material 128, pores 142 remain in the porous structural thermoset material 110.

As additionally illustrated in block 140, the pores 142 of the porous structural thermoset material 110 can be interconnected (e.g., as a network), allowing fluid to move between pores 142 through connecting pore throats 144 and ultimately through the entire material. This can assist in generating a network, which can define a pore 142 and pore throat 144 network in the resulting porous structural thermoset material 110 that is generated. In some embodiments, the pores 142 can be, for example, approximately between approximately 1 micron and 1000 microns in diameter. The pore throats 144 range in size from approximately 0.1 microns to 100 microns. The pores 142 can be non-spherical and non-ellipsoidal, with each pore 142 potentially having multiple branches and/or nodes. The pores 142 could also be anisotropic. For example, in the case of the porous structural thermoset material 110 used in a sand screen 106 (or as sand screen 106), the length scale of the pore 142 could be larger in a radial direction relative to the length scale in the angular and axial directions. In some embodiments, a sand screen 106 made from the porous structural thermoset material 110 can be designed specifically for the size distribution of sands in the formation.

The pore 142 sizes can also have a non-uniform distribution. For example, a portion of the pores 142 in the porous structural thermoset material 110 can have relatively smaller sizes, for example, to capture sand more efficiently, while another portion of the pores 142 in the porous structural thermoset material 110 can have larger sizes relative to the smaller sized pores. These larger sized pores 142 would allow the porous structural thermoset material 110 to be more permeable relative to a porous structural thermoset material 110 made with only smaller sized pores 142. In some embodiments, different removable materials 128 (i.e., having different particle sizes) can be used, for example, in conjunction with one another to generate the porous structural thermoset material 110 having differently sized pores 142. In other embodiments, the removable material 128 can be selected as having a characteristic of different particle sizes therein, thus leading to different pore 142 sizes in the porous structural thermoset material 110 when the removable material 128 is removed.

In the case of a sand screen 106, for example, smaller sized pores 142 could be located close to the formation 114 (e.g., along an outer portion of the porous structural thermoset material 110 that would be disposed most closely to and/or in direct contact with the formation 114) to inhibit sand ingress, while larger sized pores 142 can be disposed in an inner region of the porous structural thermoset material 110 (e.g., in an inner portion of the porous structural thermoset material 110 that would be disposed most closely to and/or in direct contact with the production tubing string 104) to facilitate higher permeability. The distribution of pore sizes could be bimodal (a mixture of small and large pores 142), trimodal, or simply monomodal with a large standard deviation.

It should be noted that the above technique for forming the porous structural thermoset material 110 is one example of a manner in which the porous structural thermoset material 110 can be formed. Alternatively, other operations can be included. For example, subsequent to block 136, the press 134 (or another suitable device) can be applied to the removable material 128 to compress the removable material 128 to the bottom of the mold 130. Thereafter, additional removable material 128 can be added to the thermoset composition 138 in mold 130. Optionally, a second round of compression can be applied (e.g., via the press 134) and the removable material 128 can be formed into a second layer of particles of the removable material 128 disposed above a first layer of particles of the removable material 128. This process can be repeated to generate one or more additional layers of removable material 128. Thereafter, once a desired amount of removable material 128 has been added (with the thermoset composition 138 in its uncured state as a soft solid, viscous liquid, or non-viscous liquid), block 140 can be undertaken. In this manner, layered pores 142 can be generated in the porous structural thermoset material 110.

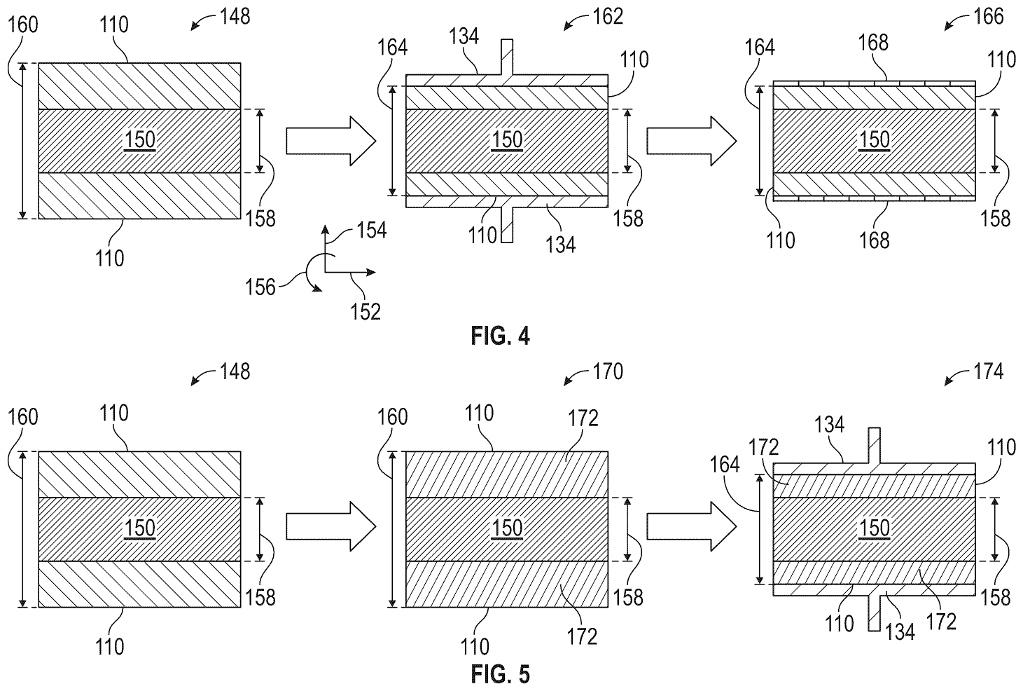

Returning to FIG. 2, in block 146 the manufactured porous structural thermoset material 110 can be compressed, for example, at the manufacturing facility 120. One technique to effect compression of the porous structural thermoset material 110 in block 146 is described below with respect to FIG. 4.

FIG. 4 illustrates a first embodiment of method of shaping the porous structural thermoset material 110 into a compressed form. For example, in block 148, a cross-sectional side view of the porous structural thermoset material 110 is illustrated. For purposes of illustration, the porous structural thermoset material 110 is illustrated as having an aperture 150 within the porous structural thermoset material 110. This aperture 150 (which can be filled with a removable support, for example) can have a diameter and/or circumference of a size approximately equivalent to the diameter and/or circumference of a tubular string 104 around which the sand screen 106 is to be disposed. That is, aperture 150 can be altered based on the environment into which the porous structural thermoset material 110 is to be used (i.e., the porous structural thermoset material 110 can be manufactured with an aperture 150 that matches the diameter and/or circumference of a tubular string 104 where it is to be deployed as part of a sand screen 106). Thus, block 148 represents the manufactured state of the porous structural thermoset material 110.

As illustrated in block 148, the porous structural thermoset material 110 has a shape that is annular (i.e., when manufacturing a sand screen 106 that is annular). That is, the porous structural thermoset material 110 extends along the aperture 150 in an axial direction 152 (mirroring how the porous structural thermoset material 110 will extend along a tubular string 104 in the axial direction 152 when in use), the porous structural thermoset material 110 extends away from the aperture 150 in a radial direction 154 (mirroring how the porous structural thermoset material 110 will extend away from tubular string 104 in the radial direction 154 and towards the formation 114 when in use), and the porous structural thermoset material 110 circumscribes the aperture 150 in a circumferential direction 156 (mirroring how the porous structural thermoset material 110 will circumscribe the tubular string 104 in the circumferential direction 156 when in use).

As additionally illustrated in FIG. 2, the aperture 150 can have a diameter 158 that, as noted above, corresponds to a diameter of a tubular string 104. Furthermore, during manufacture of the porous structural thermoset material 110, the diameter 158 can be changed to match a diameter of differing tubular strings 104. That is, the porous structural thermoset material 110 can be manufactured to various sizes that correspond to expected deployments.

Similarly, the porous structural thermoset material 110 can have a diameter 160 that extends beyond the diameter of a tubular string 104 (i.e., diameter 160 is greater than diameter 158). In some embodiments, the diameter 160 of the porous structural thermoset material 110 can be formed during manufacturing to approximately match an expected diameter of a borehole in which the porous structural thermoset material 110 (in sand screen 106) will be deployed. That is, during manufacture of the porous structural thermoset material 110, the diameter 160 can be designed and formed to predetermined sizes.

If the porous structural thermoset material 110 is deployed downhole while in its illustrated form in block 148, there can be potential issues. For example, there may be constraints during any running in hole (RIH) operation that will not allow for the deployment of the porous structural thermoset material 110 having diameter 160. Accordingly, in some embodiments, the porous structural thermoset material 110 can be compressed uphole to a smaller diameter for RIH operations.

Block 162 illustrates the porous structural thermoset material 110 as having been compressed. In conjunction with block 162, compression of the porous structural thermoset material 110 can be undertaken in some embodiments. This can be accomplished via use of a press 134 or another suitable device. In some embodiments, the compression process can be applied in different directions. Thus, in the case of manufacturing a sand screen 106 that is annular (i.e., has an annular shape), compression could be applied axially (i.e., in the axial direction 152) or radially (i.e., in the radial direction 154) to generate the desired resultant shape.

This compression process can reduce the diameter of the porous structural thermoset material 110 from a diameter 160 to a diameter 164 of the porous structural thermoset material 110. In some embodiments, diameter 164 may be reduced by, for example, approximately 20%, 30%, 33%, 40%, 50%, 60%, 65%, 70%, 75%, or another amount with respect to diameter 160. In some embodiments, the reduction in diameter resulting in the porous structural thermoset material 110 having a diameter 164 via the compression applied to the porous structural thermoset material 110 can be set as part of the manufacturing process. For example, in some embodiments, the diameter 164 of the porous structural thermoset material 110 can be formed during manufacturing to approximately match a clearance amount available for an RIH operation. That is, during manufacture of the porous structural thermoset material 110, the diameter 164 can be selected and realized to match predetermined values.

Block 166 illustrates application of a film 168 to the compressed porous structural thermoset material 110. In some embodiments, the film 168 can constitute a degradable film that operates to provide resistance to the porous structural thermoset material 110 in the radial direction 154. For example, the film 168 can be applied to an outer surface of the porous structural thermoset material 110 and can resist expansion of the porous structural thermoset material 110 away from the aperture 150. In this manner, the film 168 can operate to assist in containment of the compressed porous structural thermoset material 110 in its compressed form.

In some embodiments, the film 168 can be at least one of polyurethanes, polyesters, poly(lactic acid), poly(vinyl alcohol), a low density polyethylene (LDPE), a linear low density polyethylene (LLDPE), or another material that can be removable upon exposure to downhole fluids and heat (e.g., temperatures approximately from 70° C. to 150° or higher). For those skilled in the art, there are a host of polymeric materials that are designed to degrade downhole through various mechanisms (hydrolysis, accelerated degradation, depolymerization, etc.). In some embodiments, the film 168 can be a mixture of two or more types of removable materials. Thus, the film 168 can remain in place on the compressed form of the porous structural thermoset material 110 until deployed into position in a sand screen 106 downhole adjacent to formation 114. At that time, environmental factors (e.g., heat), can operate to degrade the film 168, allowing for subsequent expansion of the porous structural thermoset material 110 outwardly in a radial direction 154 (i.e., away from the tubular string 104) towards the formation 114 to allow the porous structural thermoset material 110, for example, interfaces with the formation 114. In some cases, heat can be supplied from not only the downhole environment, but from other supplied (e.g., artificial or man-made) sources.

The method illustrated in FIG. 4, as well as the resultant compressed form of the porous structural thermoset material 110, is useful in manufacturing, for example, a sand screen 106 that can be compressed for a RIH operation then expanded downhole when in position, i.e., adjacent to formation 114. However, other techniques can be employed to generate a compressed form of the porous structural thermoset material 110.

A second technique to effect compression of the porous structural thermoset material 110 in block 146 of FIG. 2 is described below with respect to FIG. 5. FIG. 5 illustrates a second embodiment of method of shaping the porous structural thermoset material 110 into a compressed form. Similar to FIG. 4 discussed above, FIG. 5 includes block 148 as a cross-sectional side view of the porous structural thermoset material 110 having aperture 150 and having a diameter 160. However, in contrast with the method of FIG. 4, FIG. 5 illustrates block 170 as a portion of the compression method. In block 170, containment filler 172 (containment filler material) is added to the porous structural thermoset material 110.

Containment filler 172 can be a material that, for example, may be disposed inside pores 142 of the porous structural thermoset material 110 and may operate to retain the compressed shape of the porous structural thermoset material 110 when it is compressed. In operation, the containment filler 172 inhibits the porous structural thermoset material 110 from expanding (e.g., in a radial direction 154 away from aperture 150) prematurely (i.e., prior to deployment, for example, downhole in a sand screen 106). In some embodiments, the containment filler 172 can supplement the film 168 (i.e., film 168 can be disposed over the porous structural thermoset material 110 having the containment filler 172) subsequent to it being compressed. Alternatively, the film 168 can be omitted and the containment filler 172 alone can restrict expansion by the porous structural thermoset material 110 (e.g., in a radial direction 154 away from aperture 150). Still further, in other embodiments, both the film 168 and the containment filler 172 can be omitted.

As a non-limiting example of this process, the containment filler 172 (i.e., the material within the pores 142 of the porous structural thermoset material 110) can be wax. Alternatively, the containment filler 172 can instead be made of a more rigid polymeric material that melts, for example, LDPE, LLDPE, or another low-melting point polymetric material. In some embodiment, the containment filler 172 can be a mixture of two or more types of removable materials.

In conjunction with block 170, the porous structural thermoset material 110 can be heated and submerged in molten wax (or another material as the containment filler 172). Once the wax fills the pores 142 of the porous structural thermoset material 110, the porous structural thermoset material 110 can be removed from the molten wax bath. Thereafter, in conjunction with block 174, the porous structural thermoset material 110 having the containment filler 172 is compressed and cooled. After cooling, the containment filler 172 solidifies, inhibiting the porous structural thermoset material 110 from expanding (e.g., in the radial direction 154 away from aperture 150).

Thus, block 174 illustrates the porous structural thermoset material 110 with the containment filler 172 as having been compressed. In conjunction with block 174, compression of the porous structural thermoset material 110 can be undertaken, for example, via use of press 134, or another suitable device. In some embodiments, the compression process can be applied in different directions. Thus, in the case of manufacturing a sand screen 106 that is annular (i.e., has an annular shape), compression could be applied axially (i.e., in the axial direction 152) or radially (i.e., in the radial direction 154) to generate the desired resultant shape.

This compression process can reduce the diameter of the porous structural thermoset material 110 with the containment filler 172 from a diameter 160 to a diameter 164 of the porous structural thermoset material 110 with the containment filler 172. In some embodiments, diameter 164 may be reduced by, for example, approximately 20%, 30%, 33%, 40%, 50%, 60%, 65%, 70%, 75%, or another amount with respect to diameter 160. In some embodiments, the reduction in diameter resulting in the porous structural thermoset material 110 having a diameter 164 via the compression applied to the porous structural thermoset material 110 can be set as part of the manufacturing process. For example, in some embodiments, the diameter 164 of the porous structural thermoset material 110 can be formed during manufacturing to approximately match a clearance amount available for an RIH operation. That is, during manufacture of the porous structural thermoset material 110, the diameter 164 can be selected and realized to match predetermined values.

Similar to the film 168 described above, the containment filler 172 in the pores 142 of the porous structural thermoset material 110 can be removed downhole, for example, through degradation or dissolution, allowing the porous structural thermoset material 110 to expand in a radial direction 154 away from the tubular string 104 and to conform to the wellbore 100. That is, the containment filler 172 could dissolve in the liquid hydrocarbons downhole to allow expansion of the porous structural thermoset material 110. Thus, the porous structural thermoset material 110 having the containment filler 172 can remain in place in a compressed form until deployed into position in a sand screen 106 downhole adjacent to formation 114.

At that time, environmental factors (e.g., heat), can operate to degrade the containment filler 172, allowing for subsequent expansion of the porous structural thermoset material 110 outwardly in a radial direction 154 (i.e., away from the tubular string 104) towards the formation 114 to allow the porous structural thermoset material 110, for example, interfaces with the formation 114. In some cases, heat can be supplied from not only the downhole environment, but from other supplied (e.g., artificial or man-made) sources.

Returning to FIG. 2, in block 176 the manufactured porous structural thermoset material 110 is illustrated in a compressed and constrained form. For example, as illustrated, the film 168 is present and operating to constrain expansion of the porous structural thermoset material 110 in the manner described above with respect to FIG. 4. Additionally and/or alternatively, the porous structural thermoset material 110 in block 176 can be constrained via use of the containment filler 172 in the manner described above with respect to FIG. 5. Likewise, the film 168 and/or the containment filler 172 may be omitted from the porous structural thermoset material 110 illustrated in block 176.

However, the compression of the porous structural thermoset material 110 in block 146 of FIG. 2 (as described in conjunction with FIG. 4 and FIG. 5) need not be performed, for example, at room temperature. A polymer above its T_{g} has higher polymer chain mobility and a reduced modulus compared to its state below the T_{g}. Moreover, the value of the T_{g} is dependent on a variety of factors, including the polymer type, the crosslink density, and any fluids to which the material has been exposed. Instead, the porous structural thermoset material 110 can be heated above its T_{g} and the compression (e.g., in a manner similar to that described above with respect to FIG. 4 or FIG. 5) can be performed on the porous structural thermoset material 110 while in its more flexible, rubbery state corresponding to being above its T_{g}. Heat can be removed from the porous structural thermoset material 110 (e.g., either during compression of the porous structural thermoset material 110 or after compression of the porous structural thermoset material 110) such that the ambient temperature drops to below (e.g., room temperature) the T_{g} of the porous structural thermoset material 110. For example, when applying this technique, the porous structural thermoset material 110 is compressed in conjunction with application of heat above its T_{g} with a volumetric compression ratio of about approximately from 30% to 70%, about approximately from 35% to 65%, about approximately from 40% to 60%, or another value as determined, for example, based on the borehole diameter and base pipe size (including any metallic screen configuration wrapped on it). Upon cooling, the porous structural thermoset material 110 remains in the compressed state without any change through a run-in operation and until it is deployed downhole (e.g., in the wellbore 100 adjacent a producing formation 114) to its desired position. Additionally, while the temperature applied during compression can be above the onset of T_{g}, the actual temperature can be selected based on modulus of the material.

In some embodiments, the porous structural thermoset material 110 can be mechanically as a rigid thermosetting polymer where the non-porous, bulk material (when cured to form a densely crosslinked network) has a modulus (compressive, flexural, tensile, or elastic) of at least, for example, approximately 0.7 GPa below the Tg. In other embodiments, structural thermosets typically have a Tg above ambient. Additionally, in conjunction with block 146, the porous structural thermoset material 110 can be compressed for ease of deployment and while compressed, the porous structural thermoset material 110 can remain below its T_{g}. However, similar to the techniques described above with respect to changing the size of porous structural thermoset material 110 via compression in block 146, for example, to selectively choose the size of the porous structural thermoset material 110 (and corresponding sand screen 106) to be able to approximately match a clearance amount available for an RIH operation, in some embodiments, the T_{g} of the porous structural thermoset material 110 can be altered to match operational conditions in the wellbore 100 adjacent a producing formation 114.

For example, the T_{g}can be chosen as a predetermined value during design and manufacture of the polymer in block 118. The predetermined value of T_{g} of the porous structural thermoset material 110 can be selected based on the operational temperature or bottom hole temperature (BHT) that will be present when the porous structural thermoset material 110 is deployed in the wellbore 100 adjacent a producing formation 114. The operational temperature or BHT should be much below the T_{g} of the porous structural thermoset material 110 to avoid any dynamic deformation under mechanical loading from the formation 114, which can eventually lead to reduced permeability. Thus, for example, the porous structural thermoset material 110 developed and manufactured in block 118 can have an onset T_{g} of, for example, 125.4° C. However, the onset T_{g} of the porous structural thermoset material 110 can be altered to be a temperature that occurs in a range of, for example, approximately 120° C. to 185° C.

This allows for flexibility in manufacturing the porous structural thermoset material 110 for use in various environments having a BHT that can range from, for example, approximately 60° C. to 150° C. As the value of the T_{g} of the porous structural thermoset material 110 is dependent on a variety of factors, alteration of one or more of these factors can be undertaken in block 118 to generate a porous structural thermoset material 110 with a desired T_{g}. For example, the polymer type, the crosslink density, and/or any fluids to which the porous structural thermoset material 110 has been exposed all affect the T_{g} of the porous structural thermoset material 110 and, accordingly, modifications to one or more of these factors present in the manufacturing of the porous structural thermoset material 110 can be used to control the selected the T_{g} of the porous structural thermoset material 110 that is manufactured. For example, in some embodiments, a liquid may be dissolved in the polymer whereby the liquid may have a similar chemistry to the base polymer but may be composed of low molecular weight chains (compared to most of the polymer matrix). The liquid may act as a plasticizer and can operate as a modulus suppressant and/or to reduce the T_{g} and, thus, the overall crosslinking. In general, the plasticizer (e.g., as an additive) may be added to form the porous structural thermoset material 110 and examples of plasticizers are Polybutadiene rubber, ethyl vinyl acetate, LDPE, Dioctyl phthalate, glycerol, polyurethane rubber etc.

The porous structural thermoset material 110 that is manufactured and compressed to have desired properties (i.e., to meet target dimensions with a selected T_{g}) can be transported in block 178 of FIG. 2. This can include shipment of the porous structural thermoset material 110 (e.g., as a sand screen) to a wellsite 122. At the wellsite 122, an RIH operation can be undertaken in block 180 in which the sand screen 106 is positioned adjacent to a formation 114 in the wellbore. In any embodiment in which a mechanical force (e.g., the film 168 and/or the containment filler 172) is provided as part of sand screen 106, deployment of the sand screen 106 downhole in block 180 exposes the sand screen 10 to the environment of the wellbore 100. Exposure to this environment can operate to degrade the film 168 and/or the containment filler 172, thus allowing for subsequent expansion of the porous structural thermoset material 110 and, accordingly, the sand screen 106. However, because the BHT of the wellbore is below the T_{g} of the porous structural thermoset material 110, the sand screen 106 will not expand when positioned downhole in block 180.

By utilizing a rigid material as the porous structural thermoset material 110, through the extent of its lifecycle, the sand screen 106 can exhibit a relatively simple deployment. Additionally, after the porous structural thermoset material 110 (and, accordingly, the sand screen 106) expands when the mechanical containment (i.e., the film 168 and/or the containment filler 172) is removed, the resultant expanded sand screen 106 can exhibit a high modulus and, accordingly, additional treatments to increase the modulus of the sand screen 106 to support the formation 114 may be unneeded. Additionally, for example, the lack of additional treatment downhole of the sand screen 106 can also offer increased reliability. The sand screen 106 can be prepared on the surface, allowing for inspection of the sand screen 106 before deployment. Furthermore, the reduction of processes downhole can reduce and/or eliminate potential failure modes.

In some embodiments, after expansion of the sand screen 106 within the wellbore 100, any plasticizer could be extracted. This could be accomplished, for example, either by downhole fluids or by a fluid pumped downhole. The removal of the plasticizer would increase the modulus and T_{g} of the porous structural thermoset material 110, making the resultant porous structural thermoset material 110 much stronger and more resistant to wellbore 100 collapse. For example, in many wells, the drawdown pressure is large enough to destabilize the formation 114 and cause the wellbore 100 to collapse. However, after the sand screen 106 is deployed and the plasticizer is removed, the resulting porous structural thermoset material 110 of the sand screen 106 could provide sufficient mechanical strength to support the formation 114 under these conditions.

The sand screen 106 in block 180 can be a fully hardened porous media with a relatively high modulus that remains relatively constant before and during the RIH operation. This relatively high modulus material provides higher reliability because, for example, the final properties of the sand screen 106 can be tested before deployment either at the manufacturing facility 120 or even at the wellsite 122. However, as illustrated in block 180, the sand screen 106 is still in a compressed form when positioned downhole in the wellbore 100 adjacent the producing formation 114. In some embodiments, heat will be applied to the sand screen 106 to allow for the expansion of the porous structural thermoset material 110 in block 182.

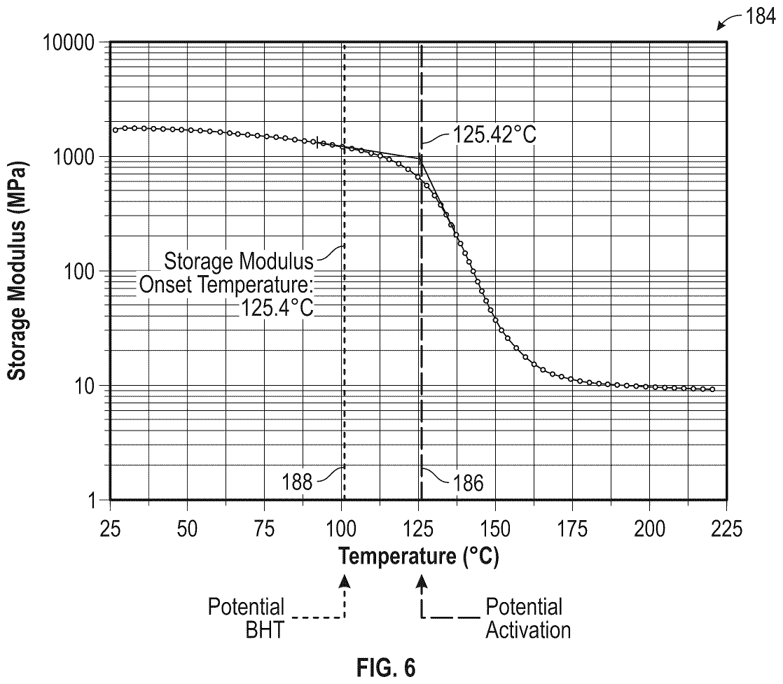

FIG. 6 illustrates a graph 184 illustrating an example of a sand screen 106 disposed positioned downhole 190 in the wellbore 100 adjacent the producing formation 114. In this example, the T_{g} onset illustrating potential activation 186 is at 125.4° C. A BHT 188 is 100° C., which is much lower than the T_{g} onset for potential activation 186. This difference in temperature reduces the risk of a premature expansion by the sand screen 106 (i.e., the porous structural thermoset material 110 can be manufactured with a target potential activation 186 at a temperature that exceeds the BHT 188 by, for example, approximately 25° C.). To expand and activate the sand screen 106 downhole 190, the screen could be heated by at least 25° C. to its T_{g} onset. During expansion, the sand screen 106 will have a lower modulus due to the higher temperature, which places less mechanical stress on the formation 114 once the sand screen conforms to the wellbore 100. The sand screen 106 will have lower storage and loss moduli, which may enable the screen to conform around any surface roughness on the wellbore 100. After expansion (in conjunction with block 182 of FIG. 2), the downhole 190 heating will subside, and the sand screen 106 temperature will return to the original BHT 188 (i.e. 100° C.) as the thermal energy dissipates into the formation 114. After returning to the temperature far below the T_{g} onset (i.e., at least 25° C. less than the T_{g} onset), the sand screen will have a high modulus, ensuring the sand screen 106 could provide sufficient support to the wellbore 100 to resist the collapse of the formation 114. Moreover, as noted above, the manufacturing process (i.e., in block 118 of FIG. 2) could be tailored to provide a desired T_{g} onset.

Returning to FIG. 2, block 182 involves expansion of the sand screen 106. As noted above, this expansion includes providing heat to the sand screen 106 to a potential activation 186 temperature corresponding to the T_{g} of the porous structural thermoset material 110. This heat may be provided to the sand screen 106 via a heat source. For example, once the sand screen 106 is positioned in conjunction with block 180, electrical power may be sent downhole 190 to heater coils, which may reside on the inside diameter (ID) of the base pipe in conjunction with block 182. The heat from these coils would pass through the base pipe to the sand screen 106, promoting expansion of the porous structural thermoset material 110. Alternatively, an exothermic reaction may be induced downhole 190 to provide additional heat. For example, calcium oxide, magnesium, and aluminum react with water to generate large amounts of heat, which is commonly utilized for self-heating food packaging. The reactants may be embedded in the degradable film 168, the pores 142 of the porous structural thermoset material 110 or even contained within the base pipe. The reactants may be designed for release only after deployment, such as by encapsulation in a degradable material. In other embodiments, a tool may be run downhole 190 into the production tubing string 104. The tool can include heating elements (e.g., heater coils) that may be electrically activated to provide heat to the sand screen 106 to a potential activation 186 temperature corresponding to the T_{g} of the porous structural thermoset material 110. Additionally and/or alternatively, the tool can provide a heated fluid (e.g., steam injection) to the sand screen 106 to heat the sand screen 106 to a potential activation 186 temperature corresponding to the T_{g} of the porous structural thermoset material 110 cause the and/or may be part of the production tubing string 104.

Application of heat at least at the T_{g} of the porous structural thermoset material 110 in block 182 causes the sand screen 106 to expand outward radially (i.e., in a radial direction 154 away from tubular string 104) and to conform to the wellbore 100. This expansion can occur after (or potentially simultaneously with) the removal/degradation of any containment material (e.g., the film 168 and/or the containment filler 172). After expansion and conformation of the sand screen to the wellbore 100 in block 182, the heat source can be deactivated in block 192. This will cause the temperature to return to the original BHT 188 as the thermal energy previously provided via the heating source dissipates into the formation 114. After returning to the BHT 188 (i.e., less than the T_{g} onset), the sand screen 106 will have a high modulus, ensuring the sand screen 106 could provide sufficient support to the wellbore 100 to resist the collapse of the formation 114. That is, the conformation of the sand screen as illustrated in block 192 will stabilize the formation 114, ensuring any loose sections of rock do not separate from the formation 114 during production. Loose rock can damage completions equipment and the formation 114, as well as increase sand production and, thus, is to be avoided.

Conformation of the sand screen 106 to the wellbore 100 is also useful for the sand screen 106 to support the wellbore 100 during drawdown. When production begins, the formation 114 can collapse onto the base pipe. For the sand screen 106 to resist the formation 114 collapse, the sand screen 106 should directly contact the formation 114 so as to provide mechanical support. In general, the conformation of the sand screen 106 to the wellbore 100 limits damage to formation 114 during production while also limiting sand production.

It should be noted that the environmental conditions downhole 190 include BHT 188 and can also include pressures (e.g., hydrostatic pressure). The sand screen 106 when exposed to temperatures above the T_{g} of the porous structural thermoset material 110, as described herein in conjunction with block 182, is able to expand despite any pressures present downhole 190. The poupous nature of the porous structural thermoset material 110 (i.e., the presence of pores 142 and/or pore throats 144 in the porous structural thermoset material 110 even when in compressed form and/or pores 142 and/or pore throats 144 in the porous structural thermoset material 110 that have been collapsed during compression can reopen during the porous structural thermoset material 110 expansion) allows for permeation even when the porous structural thermoset material 110 is exposed to pressures downhole 190. In some embodiments, the sintering (e.g., binding) of the particles of the removable material 128 during manufacture of the porous structural thermoset material 110 can result in the permeation of the compressed porous structural thermoset material 110 even in the presence of pressures downhole 190.

The technical effect of the disclosed embodiments include methods and techniques in deploying and/or activating expansion of a porous structural thermoset material 110. In some embodiments, this porous structural thermoset material 110 can be compressed to allow it to more easily be deployed downhole when used as a sand screen 106. Additionally, once downhole, exposure to an externally provided heat source provides temperatures of at least the T_{g} of the porous structural thermoset material 110 to the sand screen 106, where the T_{g} of the porous structural thermoset material 110 is selected to exceed the BHT 188. Exposure of the sand screen 106 to the externally provided temperatures of at least the T_{g} of the porous structural thermoset material 110 can cause expansion of the sand screen 106 to allow the sand screen to expand and directly contact a formation 114. Thereafter, the externally provided heat can be removed with the sand screen 106 having expanded to conform with the wellbore 100.

The subject matter described in detail above may be defined by one or more clauses, as set forth below.

A method, comprising generating a porous structural thermoset material comprising a glass transition temperature (T_{g}) that is greater than is greater than or equal to about 100° C. and a first diameter and compressing the porous structural thermoset material to generate a compressed porous structural thermoset material comprising a second diameter that is smaller than the first diameter.

The method of the preceding clause, comprising heating the porous structural thermoset material to a temperature equaling or exceeding T_{g} prior to or in conjunction with compressing the porous structural thermoset material.

The method of any preceding clauses, compressing the porous structural thermoset material at a temperature less than T_{g}.

The method of any preceding clause, comprising selecting a particular polymer as a material of the porous structural thermoset material to generate the T_{g} of the porous structural thermoset material as having a predetermined temperature value.

The method of any preceding clause, comprising selecting a particular crosslink density of the porous structural thermoset material to generate the T_{g} of the porous structural thermoset material as having a predetermined temperature value.

The method of any preceding clause, comprising selecting a particular liquid to be utilized in generating the porous structural thermoset material to generate the T_{g} of the porous structural thermoset material as having a predetermined temperature value.

The method of any preceding clause, comprising adding a containment material to the porous structural thermoset material, wherein the containment material provides a mechanical force to restrict expansion of the porous structural thermoset material in a radial direction.

The method of any preceding clause, comprising generating the porous structural thermoset material as comprising pores formed via removal of a removable material and pore throats disposed between the pores.

A device, comprising a porous structural thermoset material shaped into an annular shape, wherein the porous structural thermoset material comprises pores formed via removal of a removable material and a glass transition temperature (T_{g}) that is greater than or equal to about 100° C.

The device of the preceding clause, comprising a sand screen comprising the porous structural thermoset material.

The device of any of the preceding clauses, comprising a base pipe comprising a hollow inner portion and a metallic screen disposed about the base pipe, wherein the sand screen is disposed about the metallic screen.

The device of any of the preceding clauses, wherein the hollow inner portion is configured to receive a heat source configured to generate heat having a temperature greater than or equal T_{g} for a period of time greater than or equal to 5 minutes.

The device of any of the preceding clauses, wherein the hollow inner portion is configured to receive a heat source configured to generate heat having a temperature greater than or equal T_{g} for a predetermined period of time sufficient to conform the sand screen against a wellbore.

The device of any of the preceding clauses, comprising a containment material directly coupled to the porous structural thermoset material, wherein the containment material provides a mechanical force to restrict expansion of the porous structural thermoset material in a radial direction.

The device of any of the preceding clauses, wherein the containment material comprises a film disposed on an outer surface of the porous structural thermoset material, wherein the film is dissolvable under exposure to a temperature equal to about 60° C.

A method, comprising deploying a sand screen downhole in a wellbore, wherein the sand screen comprises compressed porous structural thermoset material having a glass transition temperature (T_{g}) that is greater than is greater than or equal to about 100° C., wherein the compressed porous structural thermoset material is disposed about a metallic screen and a base pipe comprising a hollow inner portion.

The method of the preceding clause, comprising deploying a heat source downhole to the hollow inner portion of the base pipe proximate to the sand screen; and activating the heat source to generate heat having a temperature greater than or equal T_{g} to cause expansion of the sand screen in a radial direction towards a formation adjacent the wellbore to cause the sand screen to directly contact and conform to the formation adjacent the wellbore.

The method of any preceding clauses, wherein deploying the heat source comprises deploying a rotating tool as the heat source.

The method of any preceding clauses, wherein deploying the heat source comprises deploying a non-rotating tool as the heat source.

The method of any preceding clauses, wherein deploying the heat source comprises deploying a flowing fluid into the hollow inner portion of the base pipe as the heat source.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
generating a porous structural thermoset material comprising:
a glass transition temperature (T_{g}) that is greater than is greater than or equal to about 100° C.; and
a first diameter; and
compressing the porous structural thermoset material to generate a compressed porous structural thermoset material comprising a second diameter that is smaller than the first diameter.

2. The method of claim 1, comprising heating the porous structural thermoset material to a temperature equaling or exceeding T_{g} prior to or in conjunction with compressing the porous structural thermoset material.

3. The method of claim 1, compressing the porous structural thermoset material at a temperature less than T_{g}.

4. The method of claim 1, comprising selecting a particular polymer as a material of the porous structural thermoset material to generate the T_{g} of the porous structural thermoset material as having a predetermined temperature value.

5. The method of claim 1, comprising selecting a particular crosslink density of the porous structural thermoset material to generate the T_{g} of the porous structural thermoset material as having a predetermined temperature value.

6. The method of claim 1, comprising selecting a particular liquid to be utilized in generating the porous structural thermoset material to generate the T_{g} of the porous structural thermoset material as having a predetermined temperature value.

7. The method of claim 1, comprising adding a containment material to the porous structural thermoset material, wherein the containment material provides a mechanical force to restrict expansion of the porous structural thermoset material in a radial direction.

8. The method of claim 1, comprising generating the porous structural thermoset material as comprising pores formed via removal of a removable material and pore throats disposed between the pores.

9. A device, comprising:
a porous structural thermoset material shaped into an annular shape, wherein the porous structural thermoset material comprises:
pores formed via removal of a removable material; and
a glass transition temperature (T_{g}) that is greater than or equal to about 100° C.

10. The device of claim 9, comprising a sand screen comprising the porous structural thermoset material.

11. The device of claim 10, comprising:
a base pipe comprising a hollow inner portion; and
a metallic screen disposed about the base pipe, wherein the sand screen is disposed about the metallic screen.

12. The device of claim 11, wherein the hollow inner portion is configured to receive a heat source configured to generate heat having a temperature greater than or equal T_{g} for a period of time greater than or equal to 5 minutes.

13. The device of claim 11, wherein the hollow inner portion is configured to receive a heat source configured to generate heat having a temperature greater than or equal T_{g} for a predetermined period of time sufficient to conform the sand screen against a wellbore.

14. The device of claim 9, comprising a containment material directly coupled to the porous structural thermoset material, wherein the containment material provides a mechanical force to restrict expansion of the porous structural thermoset material in a radial direction.

15. The device of claim 14, wherein the containment material comprises a film disposed on an outer surface of the porous structural thermoset material, wherein the film is dissolvable under exposure to a temperature equal to about 60° C.

16. A method, comprising:
deploying a sand screen downhole in a wellbore, wherein the sand screen comprises compressed porous structural thermoset material having a glass transition temperature (T_{g}) that is greater than is greater than or equal to about 100° C., wherein the compressed porous structural thermoset material is disposed about a metallic screen and a base pipe comprising a hollow inner portion.

17. The method of claim 16, comprising:
deploying a heat source downhole to the hollow inner portion of the base pipe proximate to the sand screen; and
activating the heat source to generate heat having a temperature greater than or equal T_{g} to cause expansion of the sand screen in a radial direction towards a formation adjacent the wellbore to cause the sand screen to directly contact and conform to the formation adjacent the wellbore.

18. The method of claim 17, wherein deploying the heat source comprises deploying a rotating tool as the heat source.

19. The method of claim 17, wherein deploying the heat source comprises deploying a non-rotating tool as the heat source.

20. The method of claim 17, wherein deploying the heat source comprises deploying a flowing fluid into the hollow inner portion of the base pipe as the heat source.
